(19) United States
(12) Patent Application Publication
(10) Pub. No.: US 2010/0074654 A1
(43) Pub. Date: Mar. 25, 2010

(54) Liquid Developer and Image Forming Apparatus

(75) Inventors: Tomotake HIRAGA, Shiojiri-shi (JP); Takashi TESHIMA, Shiojiri-shi, Nagano-ken (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/553,495

(22) Filed: Sep. 3, 2009

(30) Foreign Application Priority Data
Sep. 24, 2008 (JP) 2008-244508

(51) Int. Cl. G03G 15/01; G03G 9/13

(52) U.S. Cl. 399/233; 430/114

(57) ABSTRACT

A liquid developer includes: toner particles containing a rosin resin; an insulating liquid in which the toner particles are dispersed; and a dispersant having plural cyclic structures containing a secondary amine and/or a tertiary amine.

### CROSS-REFERENCE TO RELATED APPLICATION

The entire disclosure of Japanese Patent Application No. 2008-244508, filed Sep. 24, 2008 is expressly incorporated by reference herein.

### BACKGROUND

1. Technical Field

The present invention relates to a liquid developer and an image forming apparatus.

2. Related Art

As a developer to be used for developing an electrostatic latent image formed on a latent image carrier, a liquid developer in which a toner made of a material containing a colorant such,as a pigment and a binder resin is dispersed in an electrically insulating carrier liquid (insulating liquid) is known.

In toner particles constituting such a liquid developer, a resin material such as a polyester resin, a styrene-acrylic ester copolymer or an epoxy resin has been used. Such a resin material has characteristics that it is easy to handle, a color developing property of the resulting image is good and a high fixing property can be obtained.

However, in a traditional liquid developer, a resin material constituting toner particles and an insulating liquid had a low affinity for each other, and it was difficult to make the dispersibility of the toner particles in the insulating liquid sufficiently high.

In order to improve the dispersibility of such toner particles, an attempt to use a rosin resin with a high affinity for an insulating liquid as the resin material constituting the toner particles has been made (see, for example, Japanese Patent No. 3332961).

However, in the liquid developer described in Japanese Patent No. 3332961, although the initial dispersibility of the toner particles was good, the toner particles aggregated over time and it was difficult to maintain the dispersibility over a long period of time. Further, in the traditional liquid developer, sufficient chargeability could not be obtained, and particularly, it was difficult to obtain positive chargeability.

### SUMMARY

An advantage of some aspects of the invention is to provide a liquid developer excellent in positive chargeability and long-term dispersion stability of toner particles, and also to provide an image forming apparatus using such a liquid developer.

Such an advantage of some aspects of the invention can be achieved by the invention described below.

A liquid developer according to a first aspect of the invention includes:

toner particles containing a rosin resin;

an insulating liquid in which the toner particles are dispersed; and

a dispersant having plural cyclic structures containing a secondary amine and/or a tertiary amine.

In the liquid developer according to the first aspect of the invention, it is preferred that the rosin resin includes at least one member selected from a phenol-modified rosin resin and a polyester-modified rosin resin.

In the liquid developer according to the first aspect of the invention, it is preferred that the rosin resin has an acid value of from 3 to 40 mg KOH/g.

In the liquid developer according to the first aspect of the invention, it is preferred that the rosin resin has a weight average molecular weight of from 500 to 100000.

In the liquid developer according to the first aspect of the invention, it is preferred that the toner particles contain a polyester resin other than the rosin resin.

In the liquid developer according to the first aspect of the invention, it is preferred that the dispersant has plural carboxylic acid groups.

In the liquid developer according to the first aspect of the invention, it is preferred that the carboxylic acid groups are in the form of a salt with an alkyl ammonium ion.

In the liquid developer according to the first aspect of the invention, it is preferred that the dispersant has an ester bond with an inorganic oxo acid.

In the liquid developer according to the first aspect of the invention, it is preferred that the inorganic oxo acid is phosphoric acid.

In the liquid developer according to the first aspect of the invention, it is preferred that the dispersant has a weight average molecular weight of from 8000 to 100000.

In the liquid developer according to the first aspect of the invention, it is preferred that the cyclic structure is formed of an alkylene group and the secondary amine and/or the tertiary amine.

In the liquid developer according to the first aspect of the invention, it is preferred that the dispersant has a urethane bond in its chemical structure.

In the liquid developer according to the first aspect of the invention, it is preferred that the insulating liquid contains a fatty acid monoester.

An image forming apparatus according to a second aspect of the invention includes: plural developing parts configured to form plural

monochrome images corresponding to plural liquid developers of different colors using the plural liquid developers;

an intermediate transfer part configured such that the plural monochrome images formed in the plural developing parts are sequentially transferred thereon to form an intermediate transfer image by superimposing the transferred plural monochrome images;

a secondary transfer part configured to transfer the intermediate transfer image to a recording medium to form an unfixed color image on the recording medium; and

a fixing part configured to fix the unfixed color image on the recording medium,

wherein the liquid developers include toner particles containing a rosin resin, an insulating liquid in which the toner particles are dispersed and a dispersant having plural cyclic structures containing a secondary amine and/or a tertiary amine.

According to the above configuration, a liquid developer excellent in positive chargeability and long-term dispersion stability of toner particles can be provided. Further, an image forming apparatus using such a liquid developer can be provided.

### BRIEF DESCRIPTION OF THE DRAWINGS

The invention will be described with reference to the accompanying drawings, wherein like numbers reference like elements.

FIG. 1 is a schematic view showing an example of an image forming apparatus to which a liquid developer according to an embodiment of the invention is applied.

FIG. 2 is an enlarged view showing apart of the image forming apparatus shown in FIG. 1.

### DESCRIPTION OF EXEMPLARY EMBODIMENTS

Hereinafter, preferred embodiments of the invention are described in detail.

### Liquid Developer

First, the liquid developer of the invention is described.

The liquid developer of the invention includes toner particles containing a rosin resin, an insulating liquid in which the toner particles are dispersed and a dispersant having plural cyclic structures containing a secondary amine and/or a tertiary amine (hereinafter also referred to as “amine cyclic dispersant”).

Hereinafter, each component is described in detail.

### Toner Particles

### Constituent Material of Toner Particles

The toner particles contain at least a binder resin (resin material) and a colorant.

### 1. Resin Material (Binder Resin)

In the invention, the toner particles contain a rosin resin as the resin material.

The rosin resin is a component having a high affinity for (compatibility with) an insulating liquid as described below. Therefore, the toner particles containing such a rosin resin have particularly high dispersion stability in the insulating liquid as described below.

Further, the rosin resin has a lot of carboxylic acid groups in its chemical structure. Further, the rosin resin has a bulky three-dimensional structure and the carboxylic acid in the chemical structure is likely to be exposed on the surface of its molecule. Therefore, an amine cyclic dispersant as described below is rigidly attached to the surface of the toner particle containing the rosin resin such that the secondary amine or the tertiary amine of the amine cyclic dispersant and the carboxylic acid group of the rosin resin are attracted to each other. As a result, the dispersibility of the toner particles can be made excellent over a long period of time and also the positive chargeability of the liquid developer can be made excellent, which is described in detail below.

Incidentally, the rosin resin may exist on at least a part of the surface of the toner particle, or may be localized on the surface of the toner particle or may exist such that it covers the surface of the toner particle. In the latter case, the amine cyclic dispersant as described below can be allowed to exist (adsorbed) more in the vicinity of the surface of the toner particle.

Examples of the rosin resin include rosin-modified phenol resins, rosin-modified maleic resins, rosin-modified polyester resins, fumaric acid-modified rosin resins and ester gums. One kind or a combination of two or more kinds selected from these members can be used.

A softening point of the rosin resin as described above is preferably from 80 to 190° C., more preferably from 80 to 160° C., further more preferably from 80 to 130° C. According to this, while making the long-term dispersion stability and the chargeability of the toner particles excellent, both fixing property and heat resistant storage stability of the toner particles can be achieved at a higher level. Incidentally, the “softening point” as used herein refers to a softening initiation temperature defined by using a koka-type flow tester (manufactured by Shimadzu Corporation) under the following measurement conditions: temperature increasing rate: 5° C./min; and die diameter: 1.0 mm.

A weight average molecular weight of the rosin resin is preferably from 500 to 100000, more preferably from 1000 to 80000, further more preferably from 1000 to 10000. According to this, while making the long-term dispersion stability and the chargeability of the toner particles excellent, both fixing property and heat resistant storage stability of the toner particles can be achieved at a higher level.

An acid value of the rosin resin is preferably from 3 to 40 mg KOH/g, more preferably from 3 to 30 mg KOH/g, further more preferably from 5 to 25 mg KOH/g. According to this, the dispersant as described below can be allowed to exist (adsorbed) more in the vicinity of the surface of the toner particle.

A content of the rosin resin in the resin material constituting the toner particles is preferably from 1 to 50 wt %, more preferably from 5 to 40 wt %. According to this, the rosin resin can be allowed to more surely exist on the surface of the toner particle, and therefore the long-term dispersion stability of the toner particles can be more effectively improved.

Further, the toner particles may contain a known resin other than the rosin resin as described above,

In particular, it is preferred that the rosin resin as described above and a resin material having an ester bond are used in combination. The resin material having such a bond has a low compatibility with the rosin resin, and therefore can allow the rosin resin to more surely exist on the surface of the toner particle.

Examples of the resin material having an ester bond include polyester resins, styrene-acrylic ester copolymers and methacrylic resins. Among these, it is particularly preferred that a polyester resin is used. The polyester resin has a high transparency and when it is used as a binder resin, a color developing property of the resulting image can be made high. Further, the polyester resin has a particularly low compatibility with the rosin resin and therefore is more surely phase-separated from the rosin resin in the toner particles and can allow the rosin resin to more effectively exist on the surface of the toner particle.

An acid value of the resin material contained in the toner particles other than the rosin resin is preferably from 5 to 20 mg KOH/g, more preferably from 5 to 15 mg KOH/g. According to this, the rosin resin can be allowed to more surely exist on the surface of the toner particle, and the amine cyclic dispersant as described below can be more effectively adsorbed in the vicinity of the surface of the toner particle. As a result, the long-term dispersion stability and the positive chargeability of the toner particles can be made more excellent.

A softening point of the resin material contained in the toner particles other than the rosin resin is not particularly limited, however, it is preferably from 50 to 130° C., more preferably from 50 to 120° C., further more preferably from 60 to 115° C. According to this, the fixing property of the toner particles can be made particularly excellent.

In the case where the toner particles contain the resin having an ester bond, it is preferred that, as the resin having an ester bond, the toner particles contain two or more resin components having different weight average molecular weights. Specifically, it is preferred that, as the resin having an ester bond, the toner particles contain a first resin component having a relatively small weight average molecular weight and a second resin component having a weight average molecular weight larger than that of the first resin component. By incorporating plural types of resin components in this manner, effects as described below can be obtained.

The first resin component having a relatively small weight average molecular weight can be easily melted at a relatively low temperature. Therefore, by incorporating such a first resin component in the toner particles, even if a fixing temperature in the case of heating a toner image at fixation is relatively low (for example, between 100 and 140° C.), the first resin component can be melted together with the rosin resin, and thus, the toner particles are easily softened and rigidly fixed on a recording medium. Further, since the toner particles are relatively easily melted in this manner, the toner particles containing plural different colorants are easily melted and mixed with one another at fixation, and thus, the color developing property of the resulting toner image becomes excellent.

On the other hand, the second resin component having a relatively large weight average molecular weight is difficult to melt and soften even under a relatively high temperature environment. Therefore, by incorporating such a second resin component in the toner particles, even if the temperature of a liquid developer when the liquid developer in an unused state is stored in an image forming apparatus or the like becomes relatively high (for example, between 40 and 80° C.), the toner particles are prevented from melting or deforming. In particular, even if the first resin component or the rosin resin begins to soften under such an environment, the second resin component functions as a skeleton of the toner particles. As a result, the plural toner particles in the liquid developer are more surely prevented from adhering or aggregating to one another or deforming under the high temperature environment as described above.

Accordingly, by incorporating the first resin component and the second resin component as described above in addition to the rosin resin in the toner particles, the fixing property of the liquid developer and the long-term dispersion stability of the toner particles become particularly excellent.

In this case, a weight average molecular weight of the first resin component is preferably from 3000 to 12000, more preferably from 4000 to 10000, further more preferably from 5000 to 7000. Further, a weight average molecular weight of the second resin component is preferably from 20000 to 400000, more preferably from 50000 to 300000, further more preferably from 10000 to 250000.

A softening temperature Tf of the first resin component is preferably from 60 to 120° C., more preferably from 80 to 110° C. Further, a softening temperature Tf of the second resin component is preferably from 60 to 220° C., more preferably from 80 to 190° C.

A content of the first resin component in the resin material constituting the toner particles is preferably from 30 to 80 wt %, more preferably from 40 to 75 wt %. Further, a content of the second resin component in the resin material constituting the toner particles is preferably from 5 to 40 wt %, more preferably from 10 to 30 wt %.

### 2. Colorant

Further, the toner particles may contain a colorant. The colorant is not particularly limited, and for example, a known pigment, dye or the like can be used.

### 3. Other Components

Further, the toner particles may contain components other than the above-mentioned components. Examples of such components include a known wax and a magnetic powder.

Further, as a constituent material (component) of the toner particles, for example, zinc stearate, zinc oxide, cerium oxide, silica, titanium oxide, iron oxide, a fatty acid, a fatty acid metal salt or the like may be used other than the above-mentioned components.

### Shape of Toner Particles

An average particle diameter of the toner particles made of the material as described above is preferably from 0.5 to 3 μm, more preferably from 1 to 2.5 μm, further more preferably from 1 to 2 μm. When the average particle diameter of the toner particles falls within the above-mentioned range, a variation in properties among the toner particles can be made small, whereby the resolution of a toner image formed with the liquid developer can be made sufficiently high while making the reliability of the liquid developer as a whole high. Further, the dispersion of the toner particles in the insulating liquid can be made favorable and the storage stability of the liquid developer can be made high. The term “average particle diameter” as used herein refers to an average particle diameter by volume.

A content of the toner particles in the liquid developer is preferably from 10 to 60 wt %, more preferably from 20 to 50 wt %.

### Dispersant

Further, the liquid developer contains a dispersant.

The dispersant generally has plural polar groups in its molecule. Part of the polar groups are attached to the surface of the toner particle and the rest of the polar groups are arranged around the toner particle, whereby polarity (chargeability) and affinity for the insulating liquid are imparted to the surface of the toner particle. As a result, the dispersant has a function of improving the chargeability of the toner particles and the dispersion stability of the toner particles in the insulating liquid.

The liquid developer according to the invention contains an amine cyclic dispersant having plural cyclic structures containing a secondary amine and/or a tertiary amine as the dispersant. The amine cyclic dispersant imparts positive chargeability to the toner particles due to the secondary amine, tertiary amine and the like contained therein.

Further, the cyclic structure containing a secondary amine and/or a tertiary amine of the amine cyclic dispersant functions such that the secondary amine or the tertiary amine is attracted and attached to the carboxylic acid group of the rosin resin exposed on the surface of the toner particle as an attachment point to the toner particle. The plural cyclic structures are attached to the surface of the toner particle, whereby an attachment surface comprising the plural cyclic structures is formed in the vicinity of the surface of the toner particle.

The amine cyclic dispersant is attached to the toner particle via such an attachment surface and therefore is rigidly fixed to the toner particle. Further, if the attachment surface comprising the plural attachment points is formed in this manner, for example, even when one attachment point on the attachment surface is released from the toner particle, the other plural attachment points are attached to the toner particle, and therefore, the attachment surface in a state of being attached to the toner particle is maintained. Further, the amine cyclic dispersant once attached to the toner particle is hardly detached from the toner particle. As a result, the toner particles become excellent in dispersion stability over a long period of time and the positive chargeability thereof is maintained in an excellent state.

Moreover, since the amine cyclic dispersant detached from the toner particles is less, the amine cyclic dispersant released and present in the insulating liquid is less. Accordingly, a decrease in the insulating property of the insulating liquid due to the presence of the dispersant can be prevented. If the insulating property of the insulating liquid is maintained over a long period of time and the chargeability of the toner particles are maintained in this manner, the behavior of the toner particles against the charge during the formation of an image becomes stable and the transferring property and the developing property of the toner particles become excellent over a long period of time.

Further, it is preferred that the amine cyclic dispersant has a so-called condensed polycyclic structure in which plural cyclic structures are connected to one another. According to this, the attachment surface comprising the cyclic structures can be more easily formed and the amine cyclic dispersant is more rigidly attached to the toner particles.

Further, it is preferred that each of the cyclic structures contains plural secondary amines and/or tertiary amines. According to this, the attachment points (secondary amines and tertiary amines) of the cyclic structure to the carboxylic acid groups of the rosin resin are increased, and therefore, the amine cyclic dispersant is more rigidly attached to the toner particle.

Further, it is preferred that the amine group contained in the cyclic structure is mainly formed of a tertiary amine. According to this, the above-mentioned condensed polycyclic structure becomes large.

Further, it is preferred that the cyclic structure of the amine cyclic dispersant is formed of an alkylene group and a secondary amine and/or a tertiary amine. According to this, the cyclic structure has a large degree of freedom and is easy to deform thereby enabling close contact with the surface of the toner particle according to the unevenness of the surface. Thus, the amine cyclic dispersant is more rigidly attached to the surface of the toner particle.

The number of carbon atoms in the alkylene group is not particularly limited, however, it is preferably from 1 to 10, more preferably from 2 to 6. Further, the alkylene group may be linear or branched.

Further, it is preferred that the amine cyclic dispersant has a urethane bond in its chemical structure. According to this, the cyclic structure has a large degree of freedom and is easy to deform thereby enabling close contact with the surface of the toner particle according to the unevenness of the surface.

Further, it is preferred that the amine cyclic dispersant has plural polar end groups other than the cyclic structure. When the amine cyclic dispersant is attached to the toner particle, such end groups hardly come in direct contact with the toner particle due to the steric hindrance of the cyclic structure and are easily arranged to stand from the toner particle. Accordingly, such end groups impart chargeability to the vicinity of the surface of the toner particle. Further, in the case where the amine cyclic dispersant has polar end groups, the cyclic structure mainly functions as a structure for attachment to the toner particle. Incidentally, in the invention, in the case where the amine cyclic dispersant has polar end groups, the end groups impart positive chargeability to the toner particle.

The end group as described above may be any as long as it can impart positive chargeability to the toner particle, however, examples thereof include an end group having a carboxylic acid group forming a salt structure and an end group having an ester bond with an inorganic oxo acid. One kind or a combination of two or more kinds selected from these groups can be used.

A counterion (cation) to the carboxylic acid group which can be used to form the above-mentioned salt structure is not particularly limited, however, it is preferred to use an alkyl ammonium ion. The amine moiety of the alkyl ammonium ion can impart positive chargeability to the toner particle and the alkyl chain moiety has a function of increasing the affinity between the surface of the toner particle dispersed and the below-mentioned insulating liquid.

Further, the inorganic oxo acid to be used for the above-mentioned end group having an ester bond is not particularly limited, however, it is preferably phosphoric acid. According to this, the chargeability of the toner particle can be made excellent.

Further, the amine cyclic dispersant has a weight average molecular weight of preferably from 8000 to 100000, more preferably from 10000 to 60000.

The amine cyclic dispersant as described above is not particularly limited, however, examples thereof include Disperbyk-140, Disperbyk-142 and Disperbyk-145 (all of which are manufactured by BYK Additives & Instruments).

Further, the liquid developer may contain a dispersant other than the amine cyclic dispersant. Such a dispersant is not particularly limited and a known dispersant can be used.

Further, in the case where a dispersant other than the amine cyclic dispersant is contained, a ratio of the content of the amine cyclic dispersant to the content of the total dispersants contained in the liquid developer is preferably 50 wt % or more, more preferably 70 wt % or more.

A content of the dispersant (including the amine cyclic dispersant) in the liquid developer is preferably from 1 to 7 parts by weight, more preferably from 1.25 to 5 parts by weight based on 100 parts by weight of the toner particles. When the content of the dispersant falls within the above-mentioned range, the dispersion stability of the toner particles can be more effectively improved and also the positive chargeability thereof can be made more excellent.

### Insulating Liquid

Subsequently, the insulating liquid is described.

The insulating liquid may be any as long as it is a liquid having a sufficiently high insulating property, however, specifically, the insulating liquid has an electric resistance at room temperature (20° C.) of preferably 1×10⁹ Ωcm or more, more preferably 1×10¹¹ Ωcm or more, further more preferably 1×10¹³ Ωcm or more.

Further, a dielectric constant of the insulating liquid is preferably 3.5 or less.

Examples of the insulating liquid that satisfies the above-mentioned conditions include mineral oils (hydrocarbon liquids) such as Isopar E, Isopar G, Isopar H, Isopar L (“Isopar” is the trade name of Exxon Chemical Company), Shellsol 70, Shellsol 71 (“Shellsol” is the trade name of Shell Oil Company), Amsco OMS, Amsco 460 solvents (“Amsco” is the trade name of Spirits Co.) and low-viscosity/high-viscosity liquid paraffins (Wako Pure Chemical Industries, Ltd.), fatty acid glycerides, fatty acid esters such as fatty acid monoesters and medium-chain fatty acid esters, and vegetable oils including the same, octane, isooctane, decane, isodecane, decalin, nonane, dodecane, isododecane, cyclohexane, cyclooctane, cyclodecane, benzene, toluene, xylene and mesitylene. One kind or a combination of two or more kinds selected from these members can be used.

Among these, especially, vegetable oils have a particularly high affinity for (compatibility with) the above-mentioned rosin resin and therefore can further improve the dispersion stability of the toner particles.

Further, among the above-mentioned insulating liquids, particularly, the insulating liquid preferably contains a fatty acid monoester. The fatty acid monoester is an ester of a fatty acid with a monohydric alcohol. The fatty acid monoester has a property that easily penetrates into gaps between molecular complexes of the resin material constituting the toner particle. The fatty acid monoester incorporated in the resin material in this manner has a plasticizing effect such that it plasticizes (the resin material of) the toner particle to swell it. If the surface of the toner particle is plasticized in this manner, the carboxylic acid groups of the rosin resin in the toner particle can be exposed more and therefore the amine cyclic dispersant is more easily attached to the toner particle. Further, at fixation, the toner particle plasticized by the fatty acid monoester is easily melted even at a relatively low temperature and can be fixed on a recording medium. Further, the toner particle plasticized in this manner comes into closer contact with the recording medium and can be fixed thereon, and therefore, a fixing strength of a resulting toner image becomes particularly excellent.

Further, the fatty acid monoester can be produced by, for example, a transesterification reaction of a vegetable oil with a monohydric alcohol.

Examples of the vegetable oil subjected to the transesterification reaction include soybean oil, rapeseed oil, dehydrated castor oil, tung oil, safflower oil, linseed oil, sunflower oil, corn oil, cotton seed oil, sesame seed oil, hemp oil, evening primrose oil, palm oil (particularly palm kernel oil) and coconut oil.

Further, the fatty acid monoester may be produced by, for example, a transesterification reaction of any of various saturated-fatty acids and unsaturated fatty acids with a monohydric alcohol.

A content of the fatty acid monoester in the insulating liquid is preferably from 5 to 45 wt %, more preferably from 5 to 35 wt %, further more preferably from 10 to 20 wt %. According to this, the toner particles are more preferably plasticized.

Further, the liquid developer (insulating liquid) may contain a known antioxidant, charge control agent or the like other than the above-mentioned components.

A viscosity of the insulating liquid is not particularly limited, however, it is preferably from 5 to 1000 mPa·s, more preferably from 50 to 800 mPa·s, further more preferably from 100 to 500 mPa·s. In the case where the viscosity of the insulating liquid falls within the above-mentioned range, when the liquid developer is drawn out of a developer vessel by a coating roller, an adequate amount of the insulating liquid is adhered to the toner particles, and the developing property and transferring property of a toner image can be made particularly excellent. In addition, aggregation or precipitation of the toner particles can be effectively prevented, and the dispersibility of the toner particles in the insulating liquid can be made higher. In this connection, the term “viscosity” as used herein refers to a value obtained by measurement at 25° C.

An electric resistance at room temperature (20° C.) of such an insulating liquid is preferably 10¹¹ Ωcm or more, more preferably 10¹² Ωcm or more, further more preferably 10¹³ Ωcm or more.

Further, a dielectric constant of the insulating liquid is preferably 3.5 or less.

### Process for Producing Liquid Developer

Subsequently, a preferred embodiment of a process for producing the liquid developer according to the invention is described,

The process for producing the liquid developer according to this embodiment includes a dispersion preparing step of preparing a dispersion in which a resin material as described above and a colorant are dispersed in an aqueous dispersion medium; a coalescing step of coalescing plural dispersoids to obtain coalescent particles; a solvent removing step of removing an organic solvent contained in the coalescent particles to obtain toner particles containing the resin material and the colorant; and a dispersing step of dispersing the toner particles in an insulating liquid as well as adding an amine cyclic dispersant to the insulating liquid.

Hereinafter, the respective steps constituting the process for producing the liquid developer are described in detail.

### Dispersion Preparing Step (Aqueous Dispersion Preparing Step)

First, a dispersion (aqueous dispersion) is prepared.

The aqueous dispersion may be prepared by any method, and for example, it can be prepared as follows. A constituent material (toner material) of toner particles such as a resin material (a rosin resin and another resin material) and a colorant is dissolved or dispersed in an organic solvent to obtain a resin liquid (resin liquid preparing treatment) and an aqueous dispersion medium made of an aqueous liquid is added to the resin liquid to form dispersoids (dispersoids in a liquid state) containing the toner material in the aqueous liquid, whereby a dispersion (aqueous dispersion) in which the dispersoids are dispersed is obtained (dispersoid forming treatment).

### Resin Liquid Preparing Treatment

First, a resin liquid in which a resin material (a rosin resin and another resin material) is dissolved or dispersed in an organic solvent is prepared.

The prepared resin liquid contains a constituent material of toner particles as described above and an organic solvent as described below.

The organic solvent may be any as long as it can dissolve at least a portion of the resin material, however, it is preferred to use an organic solvent having a boiling point lower than that of an aqueous liquid described below. According to this, the organic solvent can be easily removed.

Further, the organic solvent preferably has a low compatibility with an aqueous dispersion medium (aqueous liquid) described below (for example, an organic solvent having a solubility in 100 g of the aqueous dispersion medium at 25° C. of 30 g or less). According to this, the toner material can be finely dispersed in an aqueous emulsion in a stable state.

Further, a composition of the organic solvent can be appropriately selected according to, for example, the composition of the resin material as described above and the colorant, the composition of the aqueous dispersion medium, or the like.

Such an organic solvent is not particularly limited, however, examples thereof include ketone solvents such as MEK and aromatic hydrocarbon solvents such as toluene.

The resin liquid can be obtained by mixing, for example, a resin material, a colorant, an organic solvent and the like using a stirrer or the like. Examples of the stirrer which can be used for the preparation of the resin liquid include high-speed stirrers such as DESPA (manufactured by Asada Iron Works Co., Ltd.) and T.K. Robomix/T.K. Homo Disper Model 2.5 (manufactured by Primix Corporation).

Further, a temperature of the material during stirring is preferably from 20 to 60° C., more preferably from 30 to 50° C.

A solid content in the resin liquid is not particularly limited, however, it is preferably from 40 to 75 wt %, more preferably from 50 to 73 wt %, further more preferably from 50 to 70 wt %. When the solid content falls within the above-mentioned range, the sphericity of the dispersoids constituting a dispersion (emulsified suspension) described below can be made higher (a shape close to a true sphere), and the shape of the finally obtained toner particles can be more surely made favorable.

Further, in the preparation of the resin liquid, all constituent components of the resin liquid to be prepared may be mixed simultaneously, or part of the constituent components of the resin liquid to be prepared are mixed to obtain a mixture (master mix) and thereafter, the mixture (master mix) may be mixed with the other components.

### Dispersoid Forming Treatment

Subsequently, an aqueous dispersion (dispersion) is prepared.

By adding an aqueous dispersion medium made of an aqueous liquid to the resin liquid, dispersoids (dispersoids in a liquid state) containing the toner material are formed in the aqueous liquid, whereby a dispersion (aqueous dispersion) in which the dispersoids are dispersed is obtained.

The aqueous dispersion medium is made of an aqueous liquid.

As the aqueous liquid, a liquid which is mainly made of water can be used.

In the aqueous liquid, for example, a solvent excellent in compatibility with water (for example, a solvent having a solubility in 100 parts by weight of water at 25° C. of 50 parts by weight or more) may be contained.

Further, to the aqueous dispersion medium, an emulsifying dispersant may be added as needed. By adding an emulsifying dispersant thereto, the aqueous emulsion can be more easily prepared.

The emulsifying dispersant is not particularly limited, and for example, a known emulsifying dispersant can be used.

Further, when the aqueous dispersion is prepared, for example, a neutralizing agent may be used. By using the neutralizing agent, for example, a functional group (such as a carboxyl group) in the resin material can be neutralized, and the uniformity of the shape and size of the dispersoids in the aqueous dispersion to be prepared, and the dispersibility of the dispersoids can be made particularly excellent. Consequently, the resulting toner particles have a particularly narrow particle size distribution.

The neutralizing agent may be added to, for example the resin liquid, or to the aqueous liquid.

Further, in the preparation of the aqueous dispersion, the neutralizing agent may be added in several times.

As the neutralizing agent, a basic compound can be used. Specific examples thereof include inorganic bases such as sodium hydroxide, potassium hydroxide and ammonia; and organic bases such as diethylamine, triethylamine and isopropylamine. One kind or a combination of two or more kinds selected from these members can be used. Further, the neutralizing agent may be an aqueous solution containing a compound as described above.

An addition amount of the basic compound is preferably an amount corresponding to 1 to 3 times (1 to 3 equivalents), more preferably an amount corresponding to 1 to 2 times (1 to 2 equivalents) the amount necessary for neutralizing all the carboxyl groups in the resin material. According to this, the formation of irregularly shaped dispersoids can be effectively prevented, and further, a particle size distribution of particles obtained in the coalescing step described in detail below can be made sharper.

The addition of the aqueous liquid to the resin liquid may be performed by any method, however, it is preferred that the aqueous liquid containing water is added to the resin liquid while stirring the resin liquid. That is, it is preferred that the aqueous liquid is gradually added (dropwise) to the resin liquid while applying a shearing force to the resin liquid using a stirrer or the like to cause phase conversion from a W/O-type emulsion into an O/W-type emulsion, and the aqueous dispersion in which dispersoids derived from the resin liquid are dispersed in the aqueous liquid is finally obtained.

Examples of the stirrer which can be used for the preparation of the aqueous dispersion include high-speed stirrers and high-speed dispersers such as DESPA (manufactured by Asada Iron Works Co., Ltd.), T.K. Robomix/T.K. Homo Disper Model 2.5 (manufactured by Primix Corporation); Slasher (manufactured by Mitsui Mining Co., Ltd.) and Cavitron (manufactured by Eurotec, Ltd.).

Further, during the addition of the aqueous liquid to the resin liquid, stirring is preferably performed such that a blade tip speed falls within a range from 10 to 20 m/sec, more preferably from 12 to 18 m/sec. When the blade tip speed falls within the above-mentioned range, the aqueous dispersion can be efficiently obtained and also a variation in shape and size of the dispersoids in the aqueous dispersion can be made particularly small, and the uniform dispersibility of the dispersoids can be made particularly excellent while preventing the generation of too small dispersoids and coarse particles.

A solid content in the aqueous dispersion is not particularly limited, however, it is preferably from 5 to 55 wt %, more preferably from 10 to 50 wt %. According to this, the productivity of the toner particles can be made particularly excellent while more surely preventing unwanted aggregation of the dispersoids in the aqueous dispersion.

Further, a temperature of the material in this treatment is preferably from 20 to 60° C., more preferably from 20 to 50° C.

### Coalescing Step

Subsequently, coalescent particles are obtained by coalescing the plural dispersoids (coalescing step). The coalescence of the dispersoids usually proceeds by colliding the dispersoids containing an organic solvent and combining them with one another. In the step of coalescing in this manner, since the compatibility between the rosin resin and another resin material is low, phase separation is likely to occur. Further, the rosin resin contains a lot of carboxylic acid groups and therefore has a high affinity for the aqueous liquid and is likely to be present on the surfaces of the dispersoids or coalescent particles. Accordingly, the rosin resin can be surely allowed to exist (localized) on the surfaces of the finally obtained toner particles.

The coalescence of the plural dispersoids is performed by adding an electrolyte to the dispersion while stirring the dispersion. According to this, coalescent particles can be easily and surely obtained. Further, by controlling an addition amount of the electrolyte, the particle diameter and particle size distribution of the coalescent particles can be easily and surely controlled.

The electrolyte is not particularly limited, and one kind or a combination of two or more kinds of known organic and inorganic water-soluble salts and the like can be used.

Further, the electrolyte is preferably a monovalent cationic salt. According to this, the particle size distribution of the resulting coalescent particles can be made narrow. In addition, by using a monovalent cationic salt, the generation of coarse particles can be surely prevented in this step.

Further, among the above-mentioned monovalent cationic salts, the electrolyte is preferably a sulfate (such as sodium sulfate or ammonium sulfate) or a carbonate, and particularly preferably a sulfate. According to this, the particle diameter of the coalescent particles can be particularly easily controlled.

An amount of the electrolyte to be added in this step is preferably from 0.5 to 3 parts by weight, more preferably from 1 to 2 parts by weight based on 100 parts by weight of the solid content in the dispersion to which the electrolyte is added. According to this, the particle diameter of the coalescent particles can be particularly easily and surely controlled, and also the generation of coarse particles can be surely prevented.

Further, the electrolyte is preferably added in a state of an aqueous solution. According to this, the electrolyte can be promptly diffused in the entire dispersion and also an addition amount of the electrolyte can be easily and surely controlled. As a result, the coalescent particles having a desired particle diameter and a particularly narrow particle size distribution can be obtained.

When the electrolyte is added in a state of an aqueous solution, a concentration of the electrolyte in the aqueous solution is preferably from 2 to 10 wt %, more preferably from 2.5 to 6 wt %. According to this, the electrolyte can be particularly promptly diffused in the entire dispersion and also an addition amount of the electrolyte can be easily and surely controlled.

Further, when the electrolyte is added in a state of an aqueous solution, an addition rate of the aqueous electrolyte solution is preferably from 0.5 to 10 parts by weight/min, more preferably from 1.5 to 5 parts by weight/min based on 100 parts by weight of the solid content in the dispersion to which the aqueous electrolyte solution is added. According to this, the occurrence of uneven electrolyte concentration in the dispersion can be prevented, and the generation of coarse particles can be surely prevented. In addition, the particle size distribution of the coalescent particles becomes particularly narrow. Further, by adding the electrolyte at such a rate, the coalescence rate can be particularly easily controlled, and controlling of the average particle diameter of the coalescent particles becomes particularly easy, and also the productivity of a toner can be made particularly excellent.

The electrolyte may be, added in several times. According to this, the coalescent particles having a desired size can be easily and surely obtained, and also the degree of circularity of the resulting coalescent particles can be surely made sufficiently high.

Further, this step is performed while stirring the dispersion. According to this, the coalescent particles having a particularly small variation in shape and size among the particles can be obtained.

For stirring the dispersion, a stirring blade such as an anchor blade, a turbine blade, a pfaudler blade, a fullzone blade, a maxblend blade or a crescentic blade can be used, and in particular, a maxblend blade or a fullzone blade is preferred. According to this, the added electrolyte can be promptly and uniformly dispersed or dissolved, and the occurrence of uneven electrolyte concentration can be surely prevented. Further, the dispersoids can be efficiently coalesced, and also disintegration of once formed coalescent particles can be more surely prevented. As a result, the coalescent particles having a small variation in shape and particle diameter among the particles can be efficiently obtained.

A blade tip speed of the stirring blade is preferably from 0.1 to 10 m/sec, more preferably from 0.2 to 8 m/sec, further more preferably from 0.2 to 6 m/sec. When the blade tip speed falls within the above-mentioned range, the added electrolyte can be uniformly dispersed or dissolved, and the occurrence of uneven electrolyte concentration can be surely prevented. Further, the dispersoids can be more efficiently coalesced, and also disintegration of once formed coalescent particles can be more surely prevented.

An average particle diameter of the resulting coalescent particles is preferably from 0.5 to 5 μm, more preferably from 1.5 to 3 μm. According to this, the particle diameter of the finally obtained toner particles can be made adequate.

### Solvent Removing Step

Thereafter, the organic solvent contained in the dispersion is removed. According to this, resin fine particles (toner particles) dispersed in the dispersion can be obtained. Each of the thus obtained toner particles has the rosin resin on at least a portion of the surface thereof. The removal of the organic solvent may be performed by any method, however, for example, it can be performed under reduced pressure. According to this, the organic solvent can be efficiently removed while sufficiently preventing degeneration or the like of the constituent material such as the resin material.

Further, a treatment temperature in this step is preferably lower than the glass transition point (Tg) of the resin material constituting the coalescent particles.

Further, this step may be performed in a state in which an antifoaming agent is added to the dispersion. According to this, the organic solvent can be efficiently removed.

As the antifoaming agent, for example, a lower alcohol, a higher alcohol, an oil or fat, a fatty acid, a fatty acid ester, a phosphoric acid ester or the like as well as a mineral oil antifoaming agent, a polyether antifoaming agent, or a silicone antifoaming agent can be used.

An addition amount of the antifoaming agent is not particularly limited, however, it is preferably from 20 to 300 ppm by weight, more preferably from 30 to 100 ppm by weight based on the solid content in the dispersion.

Further, in this step, at least a portion of the aqueous liquid may be removed along with the organic solvent.

Further, in this step, it is not necessary that all the organic solvent (the total amount of the organic solvent contained in the dispersion) be removed. Even if all the organic solvent is not removed, the remaining organic solvent can be sufficiently removed in another step described below.

### Washing Step

Subsequently, the thus obtained resin fine particles (toner particles) are washed (washing step).

By performing this step, even in the case where an organic solvent and the like are contained as impurities, these can be efficiently removed. As a result, the total volatile organic compound (TVOC) concentration in the finally obtained resin fine particles can be made extremely low.

This step can be performed by, for example, separating the resin fine particles through solid-liquid separation (separation from the aqueous liquid), and thereafter redispersing the solid matter (resin fine particles) in water and then performing solid-liquid separation (separation of the resin fine particles from the aqueous liquid). The procedure of redispersion of the solid matter in water and solid-liquid separation may be repeated more than once.

### Drying Step

Thereafter, by subjecting the thus obtained resin fine particles to a drying treatment, toner particles can be obtained (drying step).

The drying step can be performed using, for example, a vacuum dryer (such as Ribocone (manufactured by Okawara MFG. CO., LTD.) or Nauta (manufactured by Hosokawa Micron Corporation)), a fluidized bed dryer (manufactured by Okawara MFG. CO., LTD.) or the like.

### Dispersing Step

Subsequently, the amine cyclic dispersant is added to the insulating liquid and the thus obtained toner particles are dispersed in the insulating liquid, whereby the liquid developer is obtained.

The dispersion of the toner particles in the insulating liquid may be performed by any method, and can be performed by, for example, mixing the insulating liquid, the toner particles and the amine cyclic dispersant using a bead mill, a ball mill or the like. By mixing these components through such a method, the amine cyclic dispersant can be more surely attached or adsorbed to the surfaces of the toner particles.

Further, during this dispersion, a component other than the insulating liquid, the toner particles and the amine cyclic dispersant may be mixed.

Further, the dispersion of the toner particles and the dispersant in the insulating liquid may be performed using the total amount of the insulating liquid constituting the finally obtained liquid developer or using a portion thereof.

In the case where the toner particles and the dispersant are dispersed using a portion of the insulating liquid, after completion of the dispersion, the same liquid as used for the dispersion maybe added as the insulating liquid, or a liquid different from that used for the dispersion may be added as the insulating liquid. In the latter case, the properties such as viscosity of the finally obtained liquid developer can be easily controlled.

When the liquid developer is produced by the process as described above, each toner particle contained therein has the rosin resin on at least a portion of the surface thereof and also a variation in shape among the toner particles becomes small. Accordingly, a particle surface area does not vary among the particles and the amine cyclic dispersant can be more uniformly attached or adsorbed to the surfaces of the toner particles. As a result, while making the long-term dispersion stability of the toner particles excellent, a variation in chargeability among the toner particles can be effectively prevented and also in the development and transfer processes, the constitution of an apparatus to be used for development and transfer can be simplified.

### Image Forming Apparatus

Subsequently, a preferred embodiment of the image forming apparatus according to the invention is described. The image forming apparatus according to the invention forms a color image on a recording medium using the liquid developer of the invention as described above.

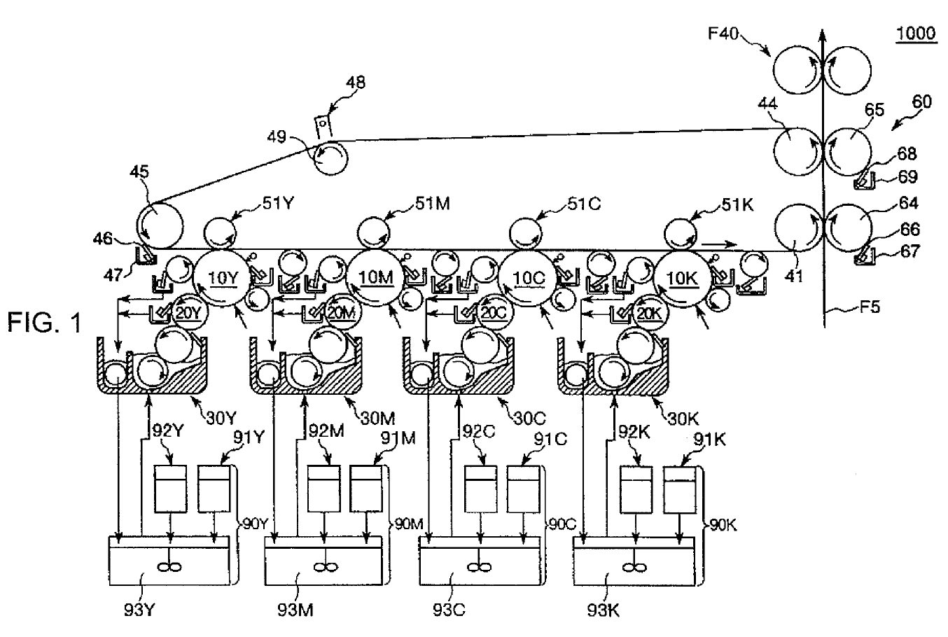

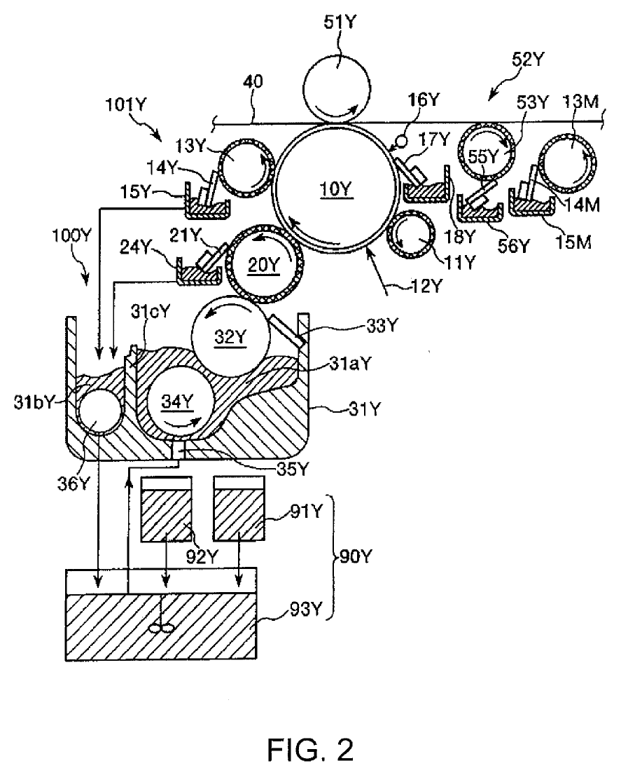

FIG. 1 is a schematic view showing a second embodiment of an image forming apparatus to which the liquid developer of the invention is applied; and FIG. 2 is an enlarged view showing a part of the image forming apparatus shown in FIG. 1.

As shown in FIGS. 1 and 2, an image forming apparatus 1000 has four developing parts 30Y, 30M, 30C and 30K, an intermediate transfer part 40, a secondary transfer unit, (secondary transfer part) 60, a fixing part (fixing device) F40, and four liquid developer replenishing parts 90Y, 90M, 90C and 90K.

The developing parts 30Y, 30M and 30C have a function of developing latent images with a yellow liquid developer (Y) a magenta liquid developer (M) and a cyan liquid developer (C), respectively, to form monochrome images corresponding to the respective colors. Further, the developing part 30K has a function of developing a latent image with a black liquid developer (K) to form a black monochrome image.

The developing parts 30Y, 30M, 30C and 30K have the same constitution, and therefore, the developing part 30Y is described below.

As shown in FIG. 2, the developing part 30Y has a photoreceptor 10Y as an example of an image carrier, and has, along the rotating direction of the photoreceptor 10Y, a charging roller 11Y, an exposure unit 12Y, a developing unit 10Y, a photoreceptor squeeze device 101Y, a primary transfer backup roller 51Y, a charge removal unit 16Y, a photoreceptor cleaning blade 17Y and a developer recovery part 18Y.

The photoreceptor 10Y has a tubular substrate and a photoreceptor layer which is formed on an outer peripheral surface of the tubular substrate and made of a material such as amorphous silicon, and is rotatable about the center axis thereof. In this embodiment, the photoreceptor 10Y rotates clockwise as shown by the arrow in FIG. 2.

The liquid developer is fed to the photoreceptor 10Y from the developing unit 100Y described below, and a layer of the liquid developer is formed on the surface thereof.

The charging roller 11Y is a device for charging the photoreceptor 10Y, and the exposure unit 12Y is a device for forming a latent image on the charged photoreceptor 10Y by irradiating laser light. The exposure unit 12Y has a semiconductor laser, a polygonal mirror, an F-θ lens and the like, and irradiates the charged photoreceptor 10Y with laser light modulated based on image signals input from a host computer (not shown) such as a personal computer or a word processor.

The developing unit 100Y is a device for developing a latent image formed on the photoreceptor 10Y with the liquid developer of the invention. The developing unit 100Y is described in detail below.

The photoreceptor squeeze device 101Y is disposed to face the photoreceptor 10Y on the downstream side of the developing unit 100Y in the rotating direction, and is constituted by a photoreceptor squeeze roller 13Y, a cleaning blade 14Y that is in press-contact with the photoreceptor squeeze roller 13Y and removes the liquid developer adhered to the surface thereof, and a developer recovery part 15Y that recovers the liquid developer removed by the cleaning blade 14Y. The photoreceptor squeeze device 101Y has a function of recovering an excess carrier (insulating liquid) and an essentially unnecessary fogging toner from the developer having been developed on the photoreceptor 10Y to increase a proportion of the toner particles in the developed image.

The primary transfer backup roller 51Y is a device for transferring the monochrome image formed on the photoreceptor 10Y to an intermediate transfer part 40 described below.

The charge removal unit 16Y is a device for removing charge remaining on the photoreceptor 10Y after transferring the intermediate transfer image to the intermediate transfer part 40 by the primary transfer backup roller 51Y.

The photoreceptor cleaning blade 17Y is a rubber member in contact with the surface of the photoreceptor 10Y and has a function of scraping and removing the liquid developer remaining on the photoreceptor 10Y after transferring the image to the intermediate transfer part 40 by the primary transfer backup roller 51Y.

The developer recovery part 18Y has a function of recovering the liquid developer removed by the photoreceptor cleaning blade 17Y.

The intermediate transfer part 40 is an endless elastic belt member and is tensioned by a belt driving roller 41 to which a driving force of a driving motor (not shown) is transmitted and a pair of driven rollers 44 and 45. Further, the intermediate transfer part 40 is rotationally driven in a counterclockwise direction by the belt driving roller 41 while coming in contact with the photoreceptors 10Y, 10M, 10C and 10K at respective positions of the primary transfer backup rollers 51Y, 51M, 51C and 51K.

A predetermined tension is applied to the intermediate transfer part 40 by a tension roller 49 so that the intermediate transfer part 40 is prevented from loosening. The tension roller 49 is disposed on the downstream side of the driven roller 44 in the rotating (moving) direction of the intermediate transfer part 40 and on the upstream side of the other driven roller 45 in the rotating (moving) direction of the intermediate transfer part 40.

Monochrome images corresponding to the respective colors formed in the developing parts 30Y, 30M, 30C and 30K are transferred sequentially to the intermediate transfer part 40 by the primary transfer backup rollers 51Y, 51M, 51C and 51K, and the monochrome images corresponding to the respective colors are superimposed on one another. In this manner, a full color developer image (intermediate transfer image) is, formed on the intermediate transfer part 40.

The intermediate transfer part 40 carries the monochrome images formed on the plural photoreceptors 10Y, 10M, 10C and 10K in a state that these images are successively secondarily transferred so as to be superimposed on one another, and the superimposed images are secondarily transferred at one time to a recoding medium F5 such as paper, film or cloth by a secondary transfer unit 60 described below. For that reason, in transferring the toner image to the recording medium F5 in the secondary transfer process, even in the case where the surface of the recording medium F5 is made of a sheet material which is not smooth due to a fibrous material, the elastic belt member is employed as a measure for increasing the secondary transfer characteristic for such a non-smooth sheet material surface.

Further, the intermediate transfer part 40 is provided with a cleaning device including an intermediate transfer part cleaning blade 46, a developer recovery part 47 and a non-contact type bias applying member 48.

The intermediate transfer part cleaning blade 46 and the developer recovery part 47 are disposed on a side of the driven roller 45.

The intermediate transfer part cleaning blade 46 has a function of scraping and removing the liquid developer adhered to the intermediate transfer part 40 after transferring the image to the recording medium F5 by the secondary transfer unit (secondary transfer part) 60.

The developer recovery part 47 has a function of recovering the liquid developer removed by the intermediate transfer part cleaning blade 46.

The non-contact type bias applying member 48 is disposed apart from the intermediate transfer part 40 at a position facing the tension roller 49. The non-contact type bias applying member 48 applies a bias voltage having a polarity opposite to that of the toner (solid matter) of the liquid developer remaining on the intermediate transfer part 40 after the secondary transfer to the toner. In this manner, the electric charge is removed from the remaining toner to decrease the electrostatic adhesion force of the toner to the intermediate transfer part 40. In this example, a corona charging device is used as the non-contact type bias applying member 48.

In this connection, the non-contact type bias applying member 48 is not necessarily disposed at the position facing the tension roller 49 and can be disposed at an arbitrary position on the downstream side of the driven roller 44 in the moving direction of the intermediate transfer part 40 and on the upstream side of the other driven roller 45 in the moving direction of the intermediate transfer part 40 such as a position between the driven roller 44 and the tension roller 49. Further, as the non-contact type bias applying member 48, any known non-contact type charging device other than the corona charging device can be also used.

Further, an intermediate transfer part squeeze device 52Y is disposed on the downstream side of the primary transfer backup roller 51Y in the moving direction of the intermediate transfer part 40.

The intermediate transfer part squeeze device 52Y is provided as a device for removing the excess insulating liquid from the liquid developer transferred to the intermediate transfer part 40 in the case where the transferred liquid developer is not in a favorable dispersed state.

The intermediate transfer part squeeze device 52Y is constituted by an intermediate transfer part squeeze roller 53Y, an intermediate transfer part squeeze cleaning blade 55Y that is in press-contact with the intermediate transfer part squeeze roller 53Y and cleans the surface thereof, and a developer recovery part 56Y that recovers the liquid developer removed by the intermediate transfer part squeeze cleaning blade 55Y.

The intermediate transfer part squeeze device 52Y has a function of recovering the excess insulating liquid from the developer primarily transferred to the intermediate transfer part 40 to increase a proportion of the toner particles in the developed image, and also recovering an essentially unnecessary fogging toner.

The secondary transfer unit 60 has a pair of secondary transfer rollers disposed apart from each other at a predetermined distance along the moving direction of the transfer member. Between these two secondary transfer rollers, the secondary transfer roller disposed on the upstream side in the moving direction of the intermediate transfer part 40 is an upstream side secondary transfer roller 64. This upstream side secondary transfer roller 64 can come in press-contact with the belt driving roller 41 via the intermediate transfer part 40.

In addition, between these two secondary transfer rollers, the secondary transfer roller disposed on the downstream side in the moving direction of the transfer member is a downstream side secondary transfer roller 65. This downstream side secondary transfer roller 65 can come in press-contact with the driven roller 44 via the intermediate transfer part 40.

That is, the upstream side secondary transfer roller 64 and the downstream side secondary transfer roller 65 each bring the recording medium F5 into contact with the intermediate transfer part 40 which is tensioned by the belt driving roller 41 and the driven roller 44 and secondarily transfer the intermediate transfer image formed on the intermediate transfer part 40 by superimposing the monochrome images of different colors to the recording medium F5.

In this case, the belt driving roller 41 and the driven roller 44 also function as backup rollers for the upstream side secondary transfer roller 64 and the downstream side secondary transfer roller 65, respectively. That is, the belt driving roller 41 also serves as an upstream side backup roller disposed on the upstream side of the driven roller 44 in the moving direction of the recording medium F5 in the secondary transfer unit 60. Further, the driven roller 44 also serves as a downstream side backup roller disposed on the downstream side of the belt driving roller 41 in the moving direction of the recording medium F5 in the secondary transfer unit 60.

Therefore, the recording medium F5 transported to the secondary transfer unit 60 is brought into close contact with the intermediate transfer part 40 in a predetermined moving region of the transfer member from a position at which press-contact between the upstream side secondary transfer roller 64 and the belt driving roller 41 starts (nip start position) to a position at which press-contact between the downstream side secondary transfer roller 65 and the driven roller 44 ends (nip end position). In this manner, the full color intermediate transfer image on the intermediate transfer part 40 is secondarily transferred to the recording medium F5 in a state of being in close contact with the intermediate transfer part 40 over a predetermined time, and thus, a favorable secondary transfer can be achieved.

Further, the secondary transfer unit 60 includes a secondary transfer roller cleaning blade 66 and a developer recovery part 67 with respect to the upstream side secondary transfer roller 64 and also includes a secondary transfer roller cleaning blade 68 and a developer recovery part 69 with respect to the downstream side secondary transfer roller 65. The secondary transfer roller cleaning blades 66 and 68 are in contact with the secondary transfer rollers 64 and 65, respectively, and scrape and remove the liquid developer remaining on the surfaces of the secondary transfer rollers 64 and 65, respectively, after secondary transfer. Further, the developer recovery parts 67 and 69 each recover and store the liquid developer scraped and removed from the respective secondary transfer rollers 64 and 65 by the respective secondary transfer roller cleaning blades 66 and 68.

The toner image (transfer image) F5a transferred to the recording medium F5 by the secondary transfer unit 60 is transported to a fixing part (fixing device) F40 and fixed to the recording medium F5 by heating and pressing.

Specifically, a fixing temperature is preferably from 80 to 160° C., more preferably from 100 to 150° C., further more preferably from 100 to 140° C.

Subsequently, the developing units 100Y, 100M, 100C and 100K are described in detail. In the following description, the developing unit 100Y is described as a representative example.

As shown in FIG. 2, the developing unit 100Y has a liquid developer storage part 31Y, a coating roller 32Y, a control blade 33Y, a developer stirring roller 34Y, a communication channel 35Y, a recovery screw 36Y, a developing roller 20Y and a developing roller cleaning blade 21Y.

The liquid developer storage part 31Y has a function of storing the liquid developer for developing a latent image formed on the photoreceptor 10Y and is provided with a feed part 31aY that feeds the liquid developer to the developing part, a recovery part 31bY that recovers the excess liquid developer generated in the feed part 31aY and the like, and a partition 31cY that separates the feed part 31aY and the recovery part 31bY.

The feed part 31aY has a function of feeding the liquid developer to the coating roller 32Y and has a concave portion in which the developer stirring roller 34Y is installed. Further, to the feed part 31aY, the liquid developer is fed through the communication channel 35Y from a liquid developer mixing bath 93Y.

The recovery part 31bY recovers the liquid developer excessively fed to the feed part 31aY and the excess liquid developer generated in the developer recovery parts 15Y and 24Y. The recovered liquid developer is transported to the liquid developer mixing bath 93Y described below for reuse. Further, the recovery part 31bY has a concave portion and a recovery screw 36Y is installed in the vicinity of the bottom of the concave portion.

At the boundary between the feed part 31aY and the recovery part 31bY, the wall-like partition 31cY is provided. The partition 31cY separates the feed part 31aY and the recovery part 31bY and can prevent contamination of the fresh liquid developer with the recovered liquid developer. Further, when the liquid developer is excessively fed to the feed part 31aY, the excess liquid developer can be allowed to overflow from the feed part 31aY to the recovery part 31bY across the partition 31cY. Therefore, the amount of the liquid developer in the feed part 31aY can be maintained constant, and the amount of the liquid developer to be fed to the coating roller 32Y can be maintained constant. As a result, the quality of the finally formed image becomes stable.

Further, the partition 31cY has a notch, and the liquid developer can be allowed to overflow from the feed part 31aY to the recovery part 31bY through the notch.

The coating roller 32Y has a function of feeding the liquid developer to the developing roller 20Y.

The coating roller 32Y is a so-called anilox roller which is a roller made of a metal such as iron, having grooves formed uniformly and spirally on the surface thereof and having been plated with nickel, and has a diameter of about 25 mm. In this embodiment, plural grooves are formed slantwise with respect to the rotating direction of the coating roller 32Y by a so-called cutting process, rolling process or the like. The coating roller 32Y is in contact with the liquid developer while rotating counterclockwise to retain the liquid developer in the feed part 31aY in the grooves, and transports the retained liquid developer to the developing roller 20Y.

The control blade 33Y is in contact with the surface of the coating roller 32Y to control the amount of the liquid developer on the coating roller 32Y. That is, the control blade 33Y plays a role in measuring an amount of the liquid developer on the coating roller 32Y to be fed to the developing roller 20Y by scraping and removing the excess liquid developer on the coating roller 32Y. This control blade 33Y is formed of urethane rubber as an elastic material and supported by a control blade supporting member made of a metal such as iron. The control blade 33Y is disposed on a side where the coating roller 32Y rotates and comes out from the liquid developer (i.e., on a right side in FIG. 2). The control blade 33Y has a rubber hardness of about 77 according to JIS-A, and the hardness of the control blade 33Y at the part in contact with the surface of the coating roller 32Y (about 77) is lower than that of the elastic layer of the developing roller 20Y described below at the part in press-contact with the surface of the coating roller 32Y (about 85). Further, the excess liquid developer thus scraped off is recovered in the feed part 31aY for reuse.

The developer stirring roller 34Y has a function of stirring the liquid developer to bring it into a uniformly dispersed state. According to this, even in the case where plural toner particles are aggregated, the respective toner particles can be favorably dispersed. In particular, the liquid developer of the invention is excellent in dispersion stability and also redispersibility, therefore, even in the case of the recycled liquid developer, the toner particles can be easily dispersed.

In the feed part 31aY, the toner particles in the liquid developer have a positive charge, and the liquid developer is brought into a uniformly dispersed state by stirring with the developer stirring roller 34Y and is drawn up from the liquid developer storage part 31Y through rotation of the coating roller 32Y, and then fed to the developing roller 20Y while controlling the amount of the liquid developer by the control blade 33Y. Further, through stirring of the liquid developer by the developer stirring roller 34Y, the liquid developer can be allowed to stably overflow across the partition 31cY to the side of the recovery part 31bY, whereby the liquid developer is prevented from being retained and compressed.

Further, the developer stirring roller 34Y is installed in the vicinity of the communication channel 35Y. Therefore, the liquid developer fed from the communication channel 35Y can be promptly diffused, and even in the case where the liquid developer is being replenished to the feed part 31aY, the level of the liquid in the feed part 31aY can be maintained constant. By installing such a developer stirring roller 34Y in the vicinity of the communication channel 35Y, a negative pressure is generated in the communication channel 35Y, and therefore, the liquid developer can be naturally sucked up.

The communication channel 35Y is provided vertically beneath the developer stirring roller 34Y and communicates with the liquid developer storage part 31Y, and through which the liquid developer is sucked up from the liquid developer mixing bath 93Y to the feed part 31aY.

By installing the communication channel 35Y beneath the developer stirring roller 34Y, the liquid developer fed through the communication channel 35Y is held back by the developer stirring roller 34Y and the liquid level is prevented from rising due to ejection of the liquid developer and the liquid level is maintained substantially constant, whereby the liquid developer can be stably fed to the coating roller 32Y.

The recovery screw 36Y installed in the vicinity of the bottom of the recovery part 31bY is formed of a cylindrical member, has spiral ribs on the outer periphery thereof, and has a function of maintaining the fluidity of the recovered liquid developer and also has a function of accelerating the transport of the liquid developer to the liquid developer mixing bath 93Y.

The developing roller 20Y retains the liquid developer and transports it to the developing position facing the photoreceptor 10Y for developing the latent image carried on the photoreceptor 10Y with the liquid developer.

The developing roller 20Y has a liquid developer layer formed on the surface thereof by feeding the liquid developer from the coating roller 32Y.

The developing roller 20Y includes an inner core made of a metal such as iron and an electroconductive elastic layer provided on the outer periphery of the core, and has a diameter of about 20 mm. The elastic layer has a two-layer structure including a urethane rubber layer having a rubber hardness of about 30 according to JIS-A and a thickness of about 5 mm as an inner layer, and a urethane rubber layer having a rubber hardness of about 85 according to JIS-A and a thickness of about 30 μm as a surface (outer) layer. The developing roller 20Y is in press-contact with the coating roller 32Y and the photoreceptor 10Y while the surface layer is serving as a press-contact portion in an elastically deformed state.

Further, the developing roller 20Y is rotatable about the center axis thereof, and the center axis is located down below the rotation center axis of the photoreceptor 10Y. The developing roller 20Y rotates in the direction (the counterclockwise direction in FIG. 2) opposite to the rotating direction (the clockwise direction in FIG. 2) of the photoreceptor 10Y. When the latent image formed on the photoreceptor 10Y is developed, an electric field is generated between the developing roller 20Y and the photoreceptor 10Y.

In the developing unit 100Y, the coating roller 32Y and the developing roller 20Y are separately driven by different power sources (not shown). Therefore, by changing a ratio of a rotation speed (linear velocity) of the coating roller 32Y to that of the developing roller 20Y, an amount of the liquid developer to be fed on the developing roller 20Y can be adjusted.

Further, the developing unit 100Y has a developing roller cleaning blade 21Y made of rubber and provided in contact with the surface of the developing roller 20Y and a developer recovery part 24Y. The developing roller cleaning blade 21Y is a device for scraping and removing the liquid developer remaining on the developing roller 20Y after the development is carried out at the developing position. The liquid developer removed by the developing roller cleaning blade 21Y is recovered in the developer recovery part 24Y.

As shown in FIGS. 1 and 2, the image forming apparatus 1000 is provided with the liquid developer replenishing parts 90Y, 90M, 90C and 90K which replenish the liquid developers to the developing parts 30Y, 30M, 30C and 30K, respectively. These liquid developer replenishing parts 90Y, 90M, 90C and 90K have liquid developer tanks 91Y, 91M, 91C and 91K, insulating liquid tanks 92Y, 92M, 92C and 92K, and liquid developer mixing baths 93Y, 93M, 93C and 93K, respectively.

In each of the liquid developer tanks 91Y, 91M, 91C and 91K, a liquid developer of high concentration which corresponds to each of the respective colors is stored. Further, in each of the insulating liquid tanks 92Y, 92M, 92C and 92K, the insulating liquid is stored. Further, to each of the liquid developer mixing baths 93Y, 93M, 93C and 93K, a predetermined amount of each liquid developer of high concentration is fed from each of the liquid developer tanks 91Y, 91M, 91C and 91K and a predetermined amount of each insulating liquid is fed from each of the insulating liquid tanks 92Y, 92M, 92C and 92K.

In each of the liquid developer mixing baths 93Y, 93M, 93C and 93K, the fed liquid developer of high concentration and the fed insulating liquid are mixed and stirred by a stirring device installed in each bath to prepare a liquid developer corresponding to each of the respective colors which is to be used in each of the feed parts 31aY, 31aM, 31aC and 31aK. The liquid developers prepared in the respective liquid developer mixing baths 93Y, 93M, 93C and 93K are fed to the corresponding feed parts 31aY, 31aM, 31aC and 31aK, respectively.

Further, in the liquid developer mixing bath 93Y, the liquid developer recovered by the recovery part 31bY is transported for reuse. The same shall apply to the liquid developer mixing baths 93M, 93C and 93K.

Here, as described above, the toner particles have a configuration in which the amine cyclic dispersant is rigidly attached to the surfaces of the toner particles containing the rosin resin. Therefore, even if stress involved in the recovering procedure (for example, stress caused by the cleaning blade) is applied to the toner particles, detachment or release of the amine cyclic dispersant from the toner particles is surely prevented, and further, the toner particles as described above have high redispersibility in the insulating liquid. Accordingly, the recovered toner particles can be favorably reused for image formation.

The invention is described hereinabove based on preferred embodiments, however, the invention is not limited to these embodiments.

For example, the liquid developer of the invention is not limited to those applied to the image forming apparatus as described above.

Further, the liquid developer of the invention is not limited to those produced by the production process as described above.

Further, in the above-mentioned embodiments, it is described that coalescent particles are obtained by preparing an aqueous emulsion and adding an electrolyte to the aqueous emulsion, however, the invention is not limited thereto. For example, the coalescent particles may be prepared using an emulsion polymerization association method in which a colorant, a monomer, a surfactant and a polymerization initiator are dispersed in an aqueous liquid, and an aqueous emulsion is prepared by emulsion polymerization, and then an electrolyte is added to the aqueous emulsion to effect association. Further, the coalescent particles may be prepared by subjecting the obtained aqueous emulsion to spray drying.

Further, in the above-mentioned embodiments, the image forming apparatus including a corona discharging device is described, however, the apparatus may not include a corona discharging device.

### Examples

### 1. Production of Liquid Developer

A liquid developer was produced as described below.

### Example 1

First, toner particles were produced. Steps in which a temperature is not specified were performed at room temperature (25° C.)

### Dispersion Preparing Step

### Preparation of Colorant Master Solution

First, as a resin material, 100 parts by weight of a polyester resin L (weight average molecular weight Mw: 5,200, glass transition temperature: 46° C., softening temperature; 95° C., acid value: 10.0 mg KOH/g) was provided.

Subsequently, a mixture of the above resin material and a cyan pigment (Pigment Blue 15:3, manufactured by Dainichiseika Color & Chemicals Mfg. Co., Ltd.) as a colorant at a mass ratio of 50:50 was prepared. These components were mixed using a 20-L Henschel mixer, whereby a raw material for producing a toner was obtained.

Then, the raw material (mixture) was kneaded using a twin-screw kneading extruder. The kneaded material extruded from the extrusion port of the twin-screw kneading extruder was cooled.

The thus cooled kneaded material was coarsely pulverized to prepare powder having an average particle diameter of 1.0 mm or less. A hammer mill was used for coarse pulverization of the kneaded material.

To the thus obtained powder of the kneaded material, methyl ethyl ketone was added such that a solid content was 30 wt %, and the resulting mixture was subjected to wet dispersion using an Eiger motor mill (M-1000, manufactured by Eiger Engineering, Ltd.) to prepare a colorant master solution.

### Resin Liquid Preparing Treatment

42.6 parts by weight of methyl ethyl ketone, 66.62 parts by weight of the polyester resin L, 28.81 parts by weight of a polyester resin H (weight average molecular weight Mw: 237,000, glass transition temperature: 63° C., softening temperature: 182° C., acid value: 9.8 mg KOH/g), 28.81 parts by weight of the rosin-modified polyester resin (trade name “Trafix 4102”, manufactured by Arakawa Chemical Industries, Ltd., acid value: 5 to 20 mg KOH/g, softening point: 120 to 150° C., weight average molecular weight: 10000 to 20000) and 1.1 parts by weight of NEOGEN SC-F (manufactured by Dai-ichi Kogyo Seiyaku Co., Ltd.) as an emulsifying agent were added to 132 parts by weight of the above-mentioned colorant master solution and all the ingredients were mixed using a high-speed disperser (T.K. Robomix/T.K. Homo Disper Model 2.5, manufactured by Primix Corporation), whereby a resin liquid was prepared. In this solution, the pigment was uniformly and finely dispersed.

### Dispersoid Forming Treatment

Subsequently, 50 parts by weight of a 1 N ammonia solution was added to the resin liquid in a vessel and the mixture was sufficiently stirred using a high-speed disperser (T.K. Robomix/T.K. Homo Disper Model 2.5, manufactured by Primix Corporation) by setting a blade tip speed of the stirring blade to 7.5 m/s, and then, a temperature of the solution in the flask was adjusted to 25° C. Thereafter, while stirring the mixture by setting a blade tip speed of the stirring blade to 14.7 m/s, 170 parts by weight of deionized water was added dropwise thereto to cause phase conversion emulsification. Further, while continuing stirring, 70 parts by weight of deionized water was added to the resin liquid, whereby an aqueous dispersion in which dispersoids containing the resin material were dispersed was obtained.

### Coalescing Step

Subsequently, the aqueous dispersion was transferred to a stirring vessel having a max blend blade, and a temperature of the aqueous dispersion was adjusted to 25° C. while stirring the aqueous dispersion by setting a blade tip speed of the stirring blade to 1.0 m/s.

Subsequently, coalescent particles were formed by adding 300 parts by weight of a 5.0% aqueous solution of ammonium sulfate dropwise to the aqueous dispersion while maintaining the same temperature and stirring conditions to coalesce the dispersoids. After completion of the dropwise addition, the mixture was kept stirring until the coalescent particles grew such that a 50% volume particle diameter Dv(50) (μm) of toner particles was 3 μm. When a Dv(50) of the coalescent particles reached 2.5 μm, 120.6 parts by weight of deionized water was added thereto and coalescence was finished.

### Solvent Removing Step

The organic solvent was distilled off until the solid content became 23 wt % by placing the resulting coalescent particle dispersion under reduced pressure, whereby a resin fine particle slurry was obtained.

### Washing Step

Subsequently, the thus obtained slurry was subjected to solid-liquid separation, and further a procedure of redispersion in water (reslurry) and solid-liquid separation was performed repeatedly to effect a washing treatment. Thereafter, a wet cake of the colored resin fine particles (resin fine particle cake) was obtained by suction filtration. A content of water in the thus obtained wet cake was 35 wt %.

### Drying Step

Thereafter, the thus obtained wet cake was dried using a vacuum dryer, whereby toner particles were obtained.

### Dispersing Step

37.5 parts by weight of the toner particles obtained by the above-mentioned method, as an amine cyclic dispersant, 1.88 parts by weight (solid content weight) of Disperbyk-140 (manufactured by BYK Additives & Instruments, weight average molecular weight: 10000 to 60000), as an insulating liquid, 135 parts by weight of rapeseed oil (trade name “high-oleic rapeseed oil” manufactured by The Nisshin Oillio Group, Ltd.) and 135 parts by weight of rapeseed oil fatty acid methyl ester (trade name “high-oleic rapeseed oil” manufactured by The Nisshin Oillio Group, Ltd.), and as a charge control agent, 0.5 parts by weight of aluminum stearate (manufactured by NOF Corporation) were placed in a ceramic pot (internal capacity: 600 mL), and further zirconia balls (ball diameter: 1 mm) were placed in the ceramic pot such that a volume filling ratio became 85%. Then, the mixture in the pot was dispersed using a desktop pot mill at a rotation speed of 230 rpm for 24 hours, and thus a liquid developer was obtained.

The toner particles in the thus obtained liquid developer had a Dv(50) of 1.85 μm. The 50% volume particle diameter Dv(50) (μm) of the obtained toner particles was measured using a particle analysis apparatus Mastersizer 2000 (manufactured by Malvern Instruments, Ltd.). Also, the particle diameters of particles obtained in the respective Examples and Comparative Examples described below were determined in the same manner.

The above-mentioned Disperbyk-140 had a condensed polycyclic structure and each cyclic structure contained plural tertiary amines and an alkylene group. Further, Disperbyk-140 had a urethane bond in its chemical structure. In addition, Disperbyk-140 had a lot of carboxylic acid groups forming a salt structure with an alkyl ammonium ion.

Further, a viscosity of the obtained liquid developer at 25° C. was 80 mPa·s.

Further, a magenta liquid developer, a yellow liquid developer and a black liquid developer were produced in the same manner as described above except that a magenta pigment (Pigment Red 122), a yellow pigment (Pigment yellow 180), a black pigment (carbon black) (Printex L, manufactured by Degussa) were used, respectively, in place of the cyan pigment.

### Examples 2 to 12

Liquid developers corresponding to the respective colors were produced in the same manner as in the above-mentioned Example 1 except that the composition or blending amount of the resin material, amine cyclic dispersant or insulating liquid was changed as shown in Table 1.

### Comparative Examples 1 to 14

Liquid developers corresponding to the respective colors were produced in the same manner as in the above-mentioned Example 1 except that the dispersant shown in Table 1 was used in place of the amine cyclic dispersant.

### Comparative Example 5

Liquid developers corresponding to the respective colors were produced in the same manner as in the above-mentioned Example 1 except that the rosin resin was not used and further the blending ratio of the resin material was changed as shown in Table 1.

With regard to the respective Examples and Comparative Examples, the compositions and physical properties of the liquid developers, the physical properties and the contents of the dispersants and the like are shown in Table 1. In the table, the rosin-modified polyester resin (trade name “Trafix 4102”, manufactured by Arakawa Chemical Industries, Ltd.) is denoted by R1; a rosin-modified phenol resin (trade name “Tamanor 361”, manufactured by Arakawa Chemical Industries, Ltd., acid value: 5 to 20 mg KOH/g, softening point: 140° C. or higher, weight average molecular weight: 10000 to 20000) is denoted by R2; a rosin-modified phenol resin (trade name “KG-2212”, manufactured by Arakawa Chemical Industries, Ltd., acid value: 6 to 22 mg KOH/g, softening point: 172 to 182° C., weight average molecular weight: 100000) is denoted by R3; the polyester resin L is denoted by L; the polyester resin H is denoted by H, Disperbyk-140 is denoted by D140; Disperbyk-142 (manufactured by BYK Additives & Instruments, weight average molecular weight: 10000 to 60000) is denoted by D142; Disperbyk-145 (manufactured by BYK Additives & Instruments, weight average molecular weight: 2000 to 8000) is denoted by D145; Arakyd 251 (manufactured by Arakawa Chemical Industries, Ltd.) is denoted by A251; Agrisperse 712 (manufactured by New Century Coatings, amine value: 100 mg KOH/g) is denoted by A712; Nimean DT208 (manufactured by NOF Corporation) is denoted by DT208; Nimean T2-202 (manufactured by NOF Corporation) is denoted by T2202; the above-mentioned rapeseed oil is denoted by L1; the above-mentioned rapeseed oil fatty acid methyl ester is denoted by L2; soybean oil (manufactured by The Nisshin Oillio Group, Ltd.) is denoted by L3; and soybean oil fatty acid methyl ester (trade name “soybean oil fatty acid methyl ester”, manufactured by The Nisshin Oillio Group, Ltd., viscosity: 5.1 mPa·s) is denoted by L4.

Further, the above-mentioned Disperbyk-142 and Disperbyk-145 had a condensed polycyclic structure and each cyclic structure contained plural tertiary amines and an alkylene group. In addition, Disperbyk-142 and Disperbyk-145 had a urethane bond in their chemical structures. Further, Disperbyk-142 and Disperbyk-145 had a phosphate ester group as an end group in a part thereof.

TABLE 1

| | Toner particles | | | | | | | |
|---|---|---|---|---|---|---|---|---|
| | | | Resin material | | Dispersant | | | |
| | | | other than | | | Content based | | |
| | Rosin resin | | rosin resin | | | on 100 parts by | Insulating liquid | |
| | | Content | | Content | | weight of toner | | Content in |
| | | in resin | | in resin | | particles | | insulating |
| | | material | | material | | (parts by | | liquid |
| | Type | (wt %) | Type | (wt %) | Type | weight) | Type | (wt %) |
| Example 1 | R1 | 20 | L/H | 60/20 | D140 | 5 | L1/L2 | 90/10 |
| Example 2 | R2 | 20 | L/H | 60/20 | D140 | 5 | L1/L2 | 90/10 |
| Example 3 | R3 | 20 | L/H | 60/20 | D140 | 5 | L1/L2 | 90/10 |
| Example 4 | R1 | 20 | L/H | 60/20 | D142 | 5 | L1/L2 | 90/10 |
| Example 5 | R1 | 20 | L/H | 60/20 | D145 | 5 | L1/L2 | 90/10 |
| Example 6 | R1 | 20 | L/H | 60/20 | D140 | 5 | L1/L2 | 94/6 |
| Example 7 | R1 | 20 | L/H | 60/20 | D140 | 5 | L1/L2 | 96/4 |
| Example 8 | R1 | 45 | L/H | 45/10 | D140 | 10 | L1/L2 | 60/40 |
| Example 9 | R1 | 35 | L/H | 50/15 | D140 | 2 | L1/L2 | 75/25 |
| Example 10 | R1 | 7 | L/H | 73/20 | D140 | 5 | L3/L4 | 85/15 |
| Example 11 | R1 | 50 | L/H | 30/10 | D140 | 0.5 | L1 | 100 |
| Example 12 | R1 | 2 | L/H | 78/20 | D140 | 5 | L1/L2 | 90/10 |
| Comparative | R1 | 20 | L/H | 60/20 | A251 | 5 | L1/L2 | 90/10 |
| Example 1 | | | | | | | | |
| Comparative | R1 | 20 | L/H | 60/20 | DT208 | 5 | L1/L2 | 90/10 |
| Example 2 | | | | | | | | |
| Comparative | R1 | 20 | L/H | 60/20 | T2202 | 5 | L1/L2 | 90/10 |
| Example 3 | | | | | | | | |
| Comparative | R1 | 20 | L/H | 60/20 | A712 | 5 | L1/L2 | 90/10 |
| Example 4 | | | | | | | | |
| Comparative | R1 | — | L/H | 80/20 | D140 | 5 | L1/L2 | 90/10 |
| Example 5 | | | | | | | | |

### 2. Evaluation of Chargeability

The respective liquid developers obtained as described above were evaluated as follows.

### 2.1. Development Efficiency

Using an image forming apparatus as shown in FIGS. 1 and 2, a liquid developer layer was formed on the developing roller of the image forming apparatus with each of the liquid developers obtained in the above-mentioned respective Examples and Comparative Examples. Subsequently, a surface potential of the developing roller was set to 300 V, and the photoreceptor was uniformly charged to a surface potential of 500 V. Then, the surface potential of the photoreceptor was attenuated to 50 V by irradiating the photoreceptor with light. The toner particles on the developing roller and the photoreceptor behind the point at which the liquid developer layer passed between the photoreceptor and the developing roller were collected using tapes, respectively. Each tape used for collecting the toner particles was stuck on a recording paper and a density of the toner particles on each tape was measured. After the measurement, a value obtained by dividing the density of the toner particles collected on the photoreceptor by the sum of the densities of the toner particles collected on the photoreceptor and the developing roller and then multiplying the resulting value by 100 was calculated as a development efficiency, which was then evaluated according to the following four grades. Incidentally, it can be said that as the development efficiency is higher, the chargeability of the toner particles is more excellent.

A: The development efficiency is 95% or more, and the development efficiency is particularly excellent.

B: The development efficiency is 90% or more and less than 95%, and the development efficiency is excellent.

C: The development efficiency is 80% or more and less than 90%, and there is no practical problem.

D: The development efficiency is less than 80%, and the development efficiency is poor.

### 2.2. Stability Over Time

The liquid developers of the respective Examples and Comparative Examples were left at room temperature for 30 days. Then, for these liquid developers, the development efficiencies were obtained in the same manner as in 2.1. A decreasing rate of the development efficiency was calculated, which was then evaluated according to the following four grades. Incidentally, as the decreasing rate of the development efficiency is smaller, a change in the chargeability of the toner particles over time is considered to be less, and therefore, it can be said that the chargeability of the liquid developer is maintained over a longer period of time.

A: The decreasing rate of the development efficiency is less than 3%.

B: The decreasing rate of the development efficiency is 3% or more and less than 5%.

C: The decreasing rate of the development efficiency is 5% or more and less than 10%.

D: The decreasing rate of the development efficiency is 10% or more.

### 3. Evaluation of Dispersion Stability

### 3.1. Dispersion Stability Test 1 (Condition 1)

First, liquid developers corresponding to the liquid developers obtained in the respective Examples and Comparative Examples were obtained in the same manner as the liquid developers obtained in the respective Examples and Comparative Examples except that the dispersant was not used. Then, a viscosity (η₀ [mPa·s]) of each of the liquid developers corresponding to the respective Examples and Comparative Examples and a viscosity (η [mPa·s]) of each of the liquid developers of the respective Examples and Comparative Examples were determined, and evaluation was performed according to the following four grades. Incidentally, as the viscosity of the liquid developer of each of Examples and Comparative Examples is lower than that of the liquid developer corresponding to each of Examples and Comparative Examples, the toner particles are considered to be more favorably dispersed, and therefore, it can be said that the dispersion stability of the toner particles is more excellent.

A: η/η₀≦0/80

B: 0.80≦η/η₀≦0.90

C: 0.90≦η/η₀≦0.95

D: 0.95≦η/η₀

### 3.2. Dispersion Stability Test 2 (Condition 2)

10 mL of each of the liquid developers obtained in the respective Examples and Comparative Examples was placed in a test tube (diameter: 12 mm, length: 120 mm) and the test tube was left stand for 30 days. Then, a depth (a vertical distance from the bottom of the test tube to the top surface of sediment of the toner particles) of sediment was measured, which was evaluated according to the following four grades.

A: The depth of sediment is 0 mm.

B: The depth of sediment is more than 0 mm and 2 mm or less.

C: The depth of sediment is more than 2 mm and 5 mm or less.

D: The depth of sediment is more than 5 mm.

### 4. Durability Test

Using an image forming apparatus as shown in FIGS. 1 and 2, an image having a predetermined pattern was formed on 10000 sheets of recording paper (High quality paper LPCPPA4 manufactured by Seiko Epson Corporation) with each of the liquid developers obtained in the respective Examples and Comparative Examples. This image formation was performed in a condition that supply of the liquid developer from each of the liquid developer tanks of respective colors to each of the corresponding stirring devices of respective colors was stopped. After image formation on 10000 sheets of recording paper was completed, a liquid developer recycled by diluting the toner particles recovered in each of the stirring devices with the insulating liquid such that a solid content became 20 wt % (recycled liquid developer) was tested in the same manner as the above-mentioned 3.2 and the durability of the toner particles was evaluated. Incidentally, it can be considered that as the dispersion stability of the toner particles in the recycled liquid developer is superior, a state in which the dispersant is sufficiently attached to the surfaces of the toner particles is easily maintained even in the environment in which stress from the outside is applied to the toner particles.

TABLE 2

| | Chargeability | | Dispersion stability | | Durability |
|---|---|---|---|---|---|
| | Development | Stability | Condition | Condi- | of toner |
| | efficiency | over time | 1 | tion 2 | particles |
| Example 1 | A | A | A | A | A |
| Example 2 | A | B | A | A | B |
| Example 3 | A | A | A | A | B |
| Example 4 | A | B | A | A | B |
| Example 5 | A | B | A | B | B |
| Example 6 | A | A | A | A | A |
| Example 7 | A | A | A | A | B |
| Example 8 | B | B | A | A | B |
| Example 9 | A | B | A | A | A |
| Example 10 | B | A | A | A | A |
| Example 11 | A | B | A | B | B |
| Example 12 | B | B | B | B | B |
| Comparative | D | D | B | D | D |
| Example 1 | | | | | |
| Comparative | C | D | B | C | D |
| Example 2 | | | | | |
| Comparative | C | D | B | C | D |
| Example 3 | | | | | |
| Comparative | C | D | B | C | D |
| Example 4 | | | | | |
| Comparative | D | D | D | D | D |
| Example 5 | | | | | |

As is apparent from Table 2, the liquid developers of the invention were excellent in chargeability (positive chargeability) and long-term dispersion stability of the toner particles. On the other hand, from the liquid developers of the Comparative Examples, satisfactory results could not be obtained.

What is claimed is:

1. A liquid developer comprising:
toner particles containing a rosin resin;
an insulating liquid in which the toner particles are dispersed; and
a dispersant having plural cyclic structures containing a secondary amine and/or a tertiary amine.

2. The liquid developer according to claim 1, wherein the rosin resin includes at least one member selected from a phenol-modified rosin resin and a polyester-modified rosin resin.

3. The liquid developer according to claim 1, wherein the rosin resin has an acid value of from 3 to 40 mg KOH/g.

4. The liquid developer according to claim 1, wherein the rosin resin has a weight average molecular weight of from 500 to 100000.

5. The liquid developer according to claim 1, wherein the toner particles contain a polyester resin other than the rosin resin.

6. The liquid developer according to claim 1, wherein the dispersant has plural carboxylic acid groups.

7. The liquid developer according to claim 6, wherein the carboxylic acid groups are in the form of a salt with an alkyl ammonium ion.

8. The liquid developer according to claim 1, wherein the dispersant has an ester bond with an inorganic oxo acid.

9. The liquid developer according to claim 8, wherein the inorganic oxo acid is phosphoric acid.

10. The liquid developer according to claim 1, wherein the dispersant has a weight average molecular weight of from 8000 to 100000.

11. The liquid developer according to claim 1, wherein the cyclic structure is formed of an alkylene group and the secondary amine and/or the tertiary amine.

12. The liquid developer according to claim 1, wherein the dispersant has a urethane bond in its chemical structure.

13. The liquid developer according to claim 1, wherein the insulating liquid contains a fatty acid monoester.

14. An image forming apparatus comprising:
plural developing parts configured to form plural monochrome images corresponding to plural liquid developers of different colors using the plural liquid developers;
an intermediate transfer part configured such that the plural monochrome images formed in the plural developing parts are sequentially transferred thereon to form an intermediate transfer image by superimposing the transferred plural monochrome images;
a secondary transfer part configured to transfer the intermediate transfer image to a recording medium to form an unfixed color image on the recording medium; and
a fixing part configured to fix the unfixed color image on the recording medium,
wherein the liquid developers include toner particles containing a rosin resin, an insulating liquid in which the toner particles are dispersed and a dispersant having plural cyclic structures containing a secondary amine and/or a tertiary amine.
